(19) United States
(12) Patent Application Publication
(10) Pub. No.: US 2013/0009788 A1
(43) Pub. Date: Jan. 10, 2013

(54) Utility Electric Meter Web Server

(75) Inventors: Daniel Langenberg, Maryland Heights, MO (US); Christopher Fleck, St. Louis, MO (US); David Steidtmann, St. Louis, MO (US)

(73) Assignee: ACLARA POWER-LINE SYSTEMS, INC., St. Louis, MO (US)

(21) Appl. No.: 13/347,242

(22) Filed: Jan. 10, 2012

Related U.S. Application Data
(60) Provisional application No. 61/437,094, filed on Jan. 28, 2011.

(51) Int. Cl. G08C 15/06

(52) U.S. Cl. 340/870.02

(57) ABSTRACT

A meter (M) installed by a utility at a customer site to measure the usage of a commodity supplied by the utility to the customer comprises an enclosure (E) in which is installed measuring apparatus (A) for measuring the amount of usage of the commodity by the customer at any one time. A web server (S) provides information obtained from the measuring apparatus and the utility to the customer. A wireless connection (C) between the web server and a customer device (D) allows the information and utility provided information to be displayed to the customer as well as enabling the device to obtain information from the meter so to determine when, and for how long, the device can be most cost efficiently operated.

### CROSS-REFERENCE TO RELATED APPLICATIONS

U.S. provisional patent application 61/437,094 filed Jan. 28, 2011.

### STATEMENT REGARDING FEDERALLY SPONSORED RESEARCH

Not Applicable.

### BACKGROUND OF THE INVENTION

This invention relates to electric meters of the type installed at homes and businesses to monitor electricity usage at the site; and, more particularly, to a web server installed in an electric meter and used, in addition to providing information concerning electricity usage to an electrical utility, to provide information to the home owner or business owner concerning current energy consumption, energy consumption over a period of time (i.e., a billing cycle), current costs for levels of energy usage, programming of energy usage by appliances at the home or business, comparison shopping for different energy providers, and other information helpful to the home or business owner in understanding his energy costs and how better to control them while using the energy supplied as efficiently and economically as possible.

Electric meter technology has substantially increased in recent times. No longer does a meter simply provide an indication of energy usage at a particular time and allow a utility to bill for usage during a billing cycle. Rather, “smart” meters are now in use which enable a utility to not only monitor usage, but to also control it. In addition, these meters are also capable of providing the owner or user of the facility at which they are installed with up-to-date information regarding the energy usage. This has the advantage of increasing consumer knowledge concerning their electricity usage, and also enables the owner or user to use the energy more efficiently than has previously been possible.

In this regard, monthly bills from the utility are too slow. Utility web pages which can contain significant amounts of pertinent information require users to have internet access and the ability to remember their login information. Wireless protocols such as Zigbee®, for example, (similar to Bluetooth®) can provide information quickly, but their usage involves a number of hardware devices which significantly increases system cost. And, use of these devices is not widespread and would therefore require a utility to provide them to their customers. This would impose an initial cost and additional installation/service/maintenance costs which a utility may not want to bear.

As to other means of communication, the internet has been used to deliver information to a utility. A drawback with this approach, however, is that it requires a customer to always have “on” an internet connection. Further, it is not available to all customers, particularly those in rural areas, who only have a dial-up connection or no home internet service at all.

In accordance with the present invention, having an electric meter with a web server installed allows meter data to be instantaneously available to a consumer over their network.

### BRIEF SUMMARY OF THE INVENTION

The present disclosure is directed to a utility meter such as an electric meter, gas meter, or water meter, with a web server installed in the meter. The server implements IEEE 802.11 standards and readily interfaces with devices customers already have. These devices include personal computers (PCs) such as laptop computers, televisions (TVs), smart phones, personal digital assistants (PDAs) and portable media players, game consoles, entertainment centers, and other internet enabled devices. The web server is connected to a customer's network (e.g., LAN) using, for example, a Wi-Fi® router, or simply connected directly to a customer device via an ad-hoc type connection for customers who do not have an existing home network.

Meter information is displayed to a customer using standard web browser protocols which are directly connected to the meter. No internet access is required, and the connection between the meter and the customer can be a secure connection.

The meter and web server allow a wide range of information to be provided to the customer. This information includes:

a) electricity usage including instantaneous usage, usage over an interval of time, or a summary of usage;

b) pricing information as to the cost of electricity which can include tiered pricing information, time-of-use pricing, and other utility pricing schemes;

c) customized pricing information that allows the customer to compare the effects of alternate energy rate plans;

d) the current cost of usage, past usage costs, predicted costs for future usage;

e) messages from the utility;

f) consumer configurable items including, for example, Wi-Fi settings as well as, for example, price settings for the commodity whose usage is monitored by the meter; and,

g) other information.

In addition to the above, the invention also allows interfaces with devices and appliances or equipment at the customer site including such things as thermostats, heaters, air conditioners, and other home area network (HAN) devices, as well as industrial machinery. The appliances and machinery can be internet enabled for communications with the meter using the local area network.

The meter is easy to install either as original equipment at a site, or as a replacement or retrofit unit, is readily serviced, and can be replaced, if necessary, with minimal disruption to the customer.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a block diagram of a first embodiment of the invention;

FIG. 2 is a block diagram of a second embodiment of the invention;

FIG. 3 is a block diagram of a third embodiment of the invention;

FIG. 4 is a block diagram schematic of one embodiment of the web server; and,

FIGS. 5-11 are representative screen displays available to the consumer through use of the web server and illustrating the range of information which can be provided to the consumer.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to FIGS. 1-3, a meter M is installed by a utility at a customer site. The meter is used to measure the usage of a commodity; i.e., electricity, supplied by the utility to the customer. Meter M includes a housing or enclosure E in which is installed measuring apparatus A for measuring the amount of usage of the commodity (electricity) by the customer at any one time. Apparatus for measuring electricity usage is well-known in the art, and is not described. In addition to apparatus A, a web server S is also installed in the enclosure. The web server provides information obtained from the apparatus A and information (including instructions and data) provided by the utility to the customer. In addition, a wireless communications module C is also installed in the enclosure. Module C, which provides wireless access in accordance with the IEEE 802.11 standards, facilitates the transfer of information between web server S and a customer device D for the information obtained by apparatus A, and utility provided information, to be timely displayed to the customer. This information can also include electronic messages (emails). Device D can be at least one of a plurality of devices including, but not limited to, a personal computer (PC) including a laptop computer, a television (TV), any of a variety of smart phones, personal digital assistants (PDAs), portable media players such as an i Pod®, a game console, or an entertainment center.

More particularly, in the embodiment of the invention shown in FIG. 1, meter M provides the information to a customer through a wireless router R with the connection between the router and customer device being wired or wireless. Router R is also compatible with the IEEE 802.11 standards.

In the embodiment of FIG. 2, the connection between meter M and the customer device D is accomplished using an ad hoc mode of communication, rather than through a router. Wireless communications module C creates the ad hoc network so that any properly configured customer device D can connect to the server. For this purpose, the customer will use their own router information, using, for example, their identification (SSID) and password. Web server S is then connected to the customer's designated router and meter M is connected to the customer's network. It will be further appreciated by those skilled in the art that other possible communication methods include Bluetooth®, serial communications through an optical port, various methods of power line communications, RF, and other methods.

In the embodiment of FIG. 3, connection between meter M and customer device D is through the internet. In this configuration, the output of wireless communications module C is to a wireless router R, and internet gateway G to the internet. From the internet, communications to the device is directed either through a third party server T or another internet gateway W.

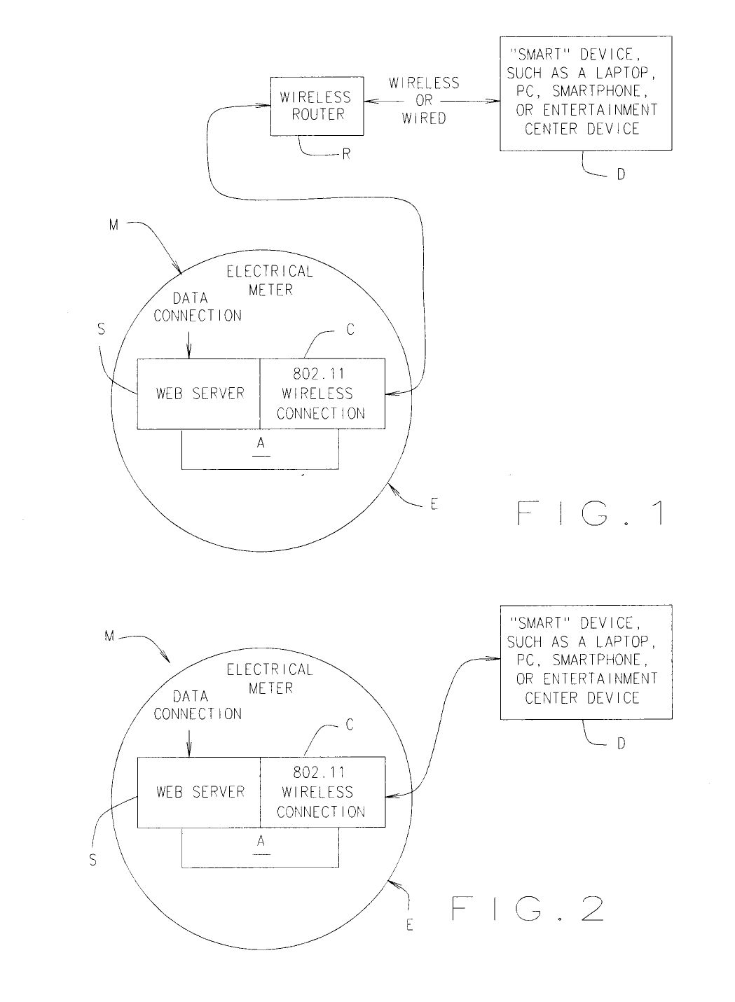

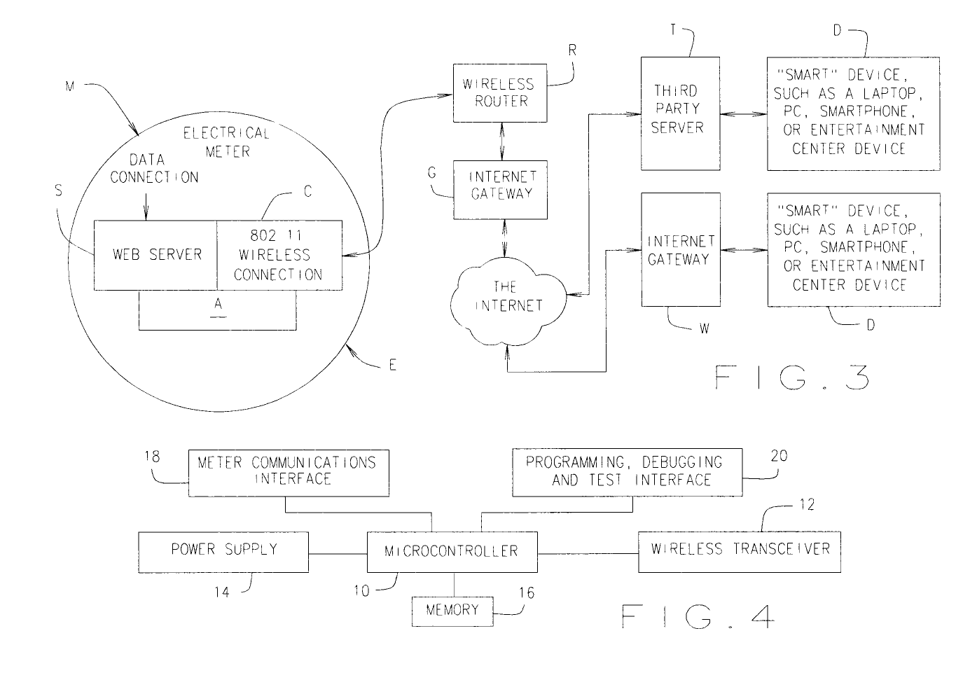

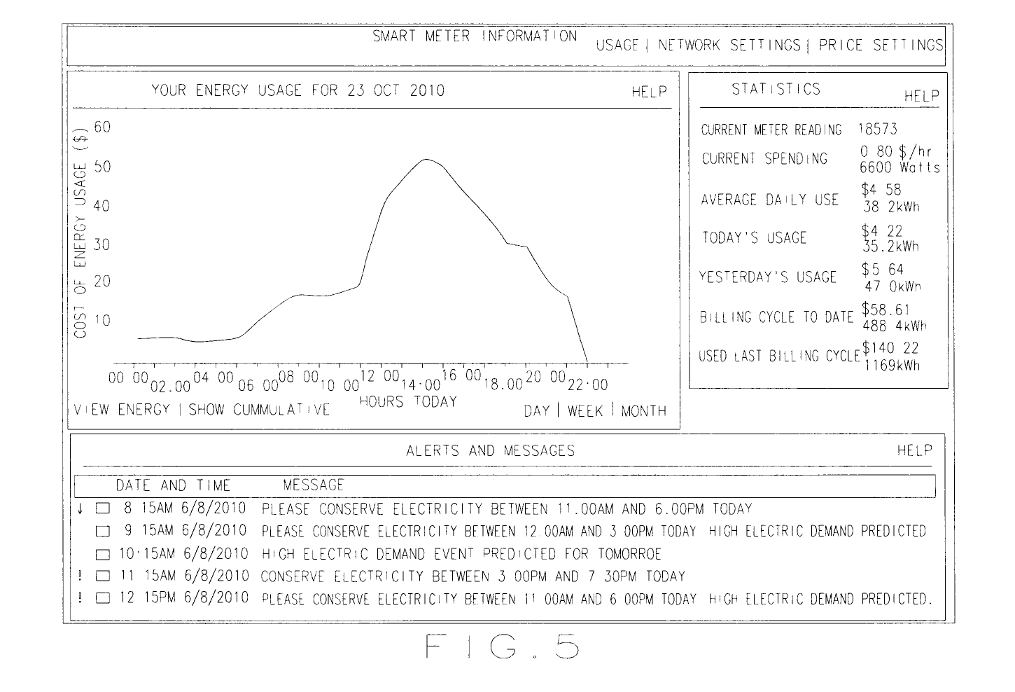

Referring to FIG. 4, web server S includes a microcontroller 10 which is combined with an RF transceiver 12 for communication between meter M and external devices such as wireless router R. Microcontroller 10 incorporates all the hardware and software required to function as a web server. This includes, for example, a transmission control protocol (TCP), a hypertext transfer protocol (HTTP), internet protocol version 4 (IPV4) or version 6 (IPV6), and a secure sockets layer (SSL) used to manage the security of message transmission over the internet so that all communications can be over a secure network. While microcontroller 10 typically will effect communications in a hypertext markup language (HTML), those skilled in the art will understand that it can also utilize web compliant communication methods including, but not limited to, ASP, Java, JavaScript, Cascading Style Sheets (CSS), Flash, XML, and AJAX. In addition to microcontroller 10 and RF transceiver 12, web server S further includes its own power supply 14, memory 16, meter communications module 18, and a program/test module 20.

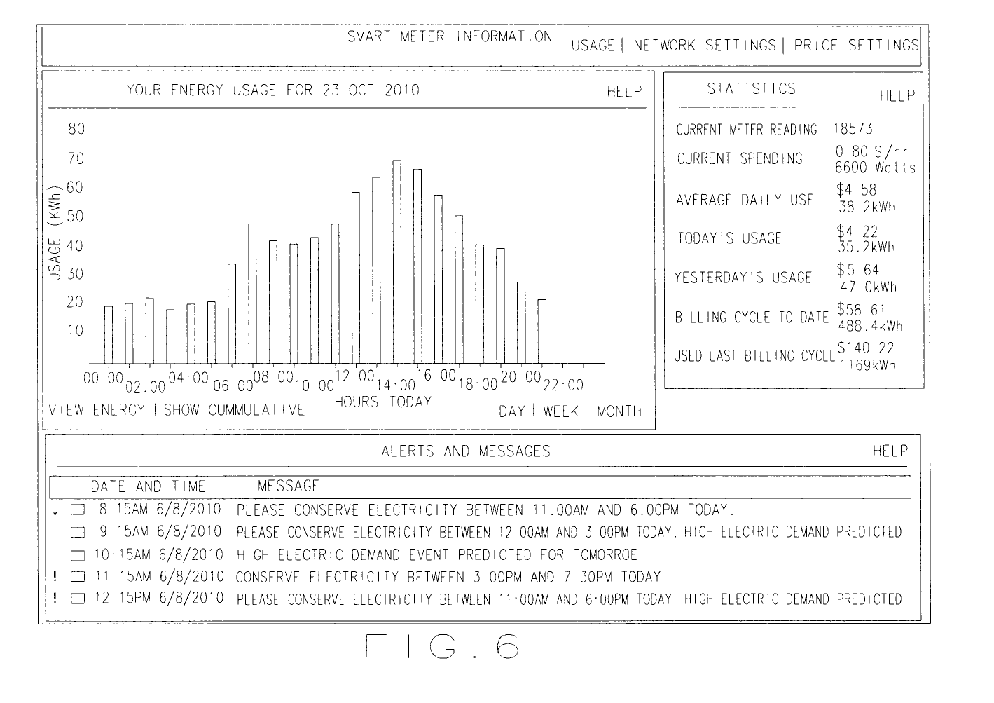

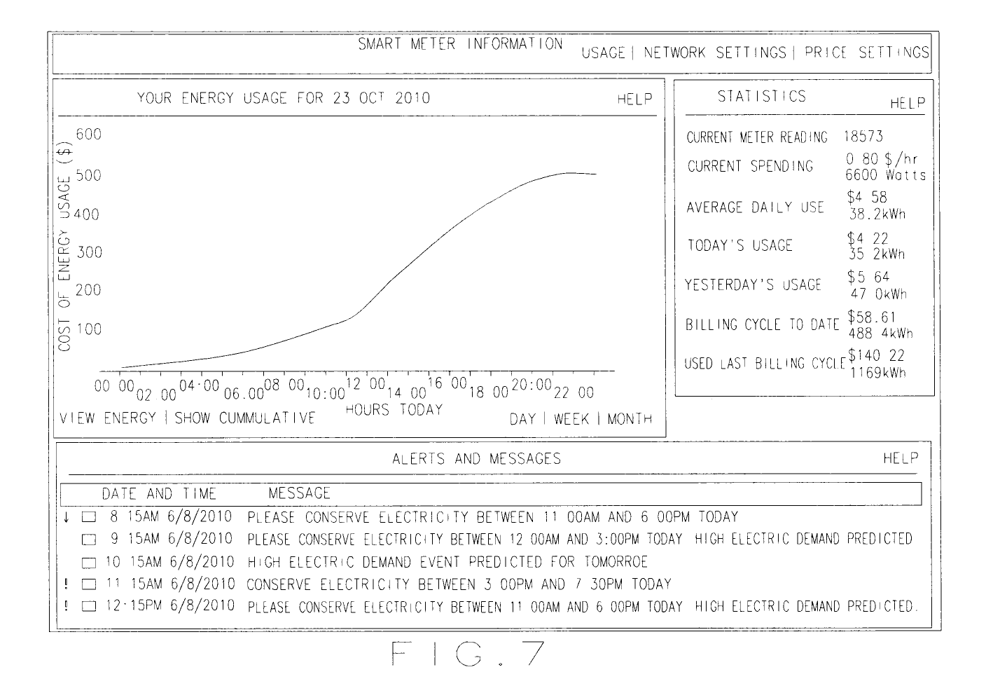

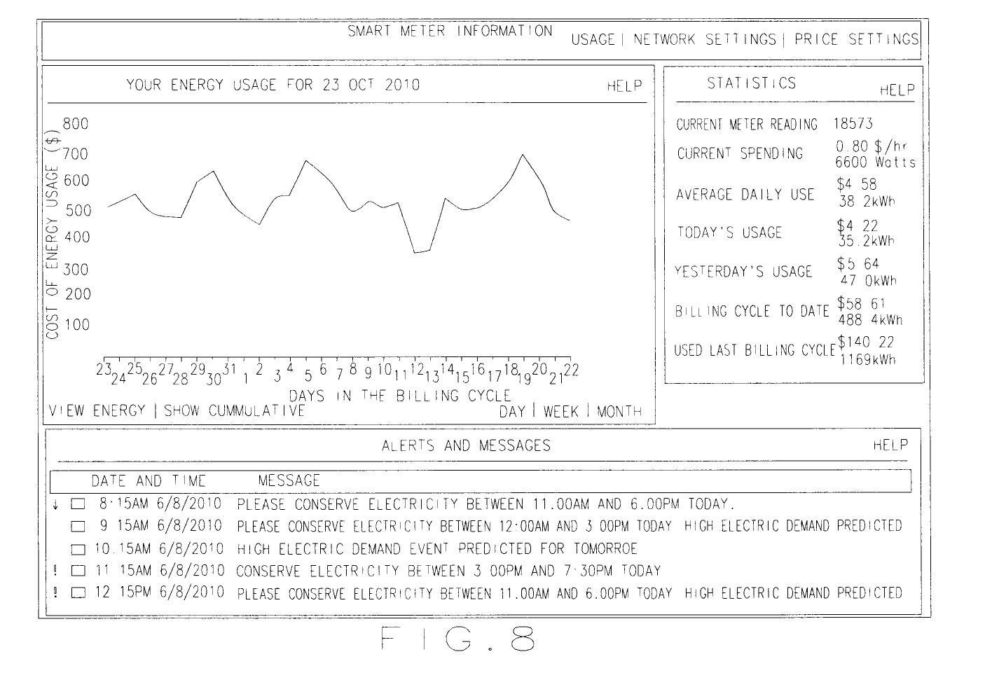

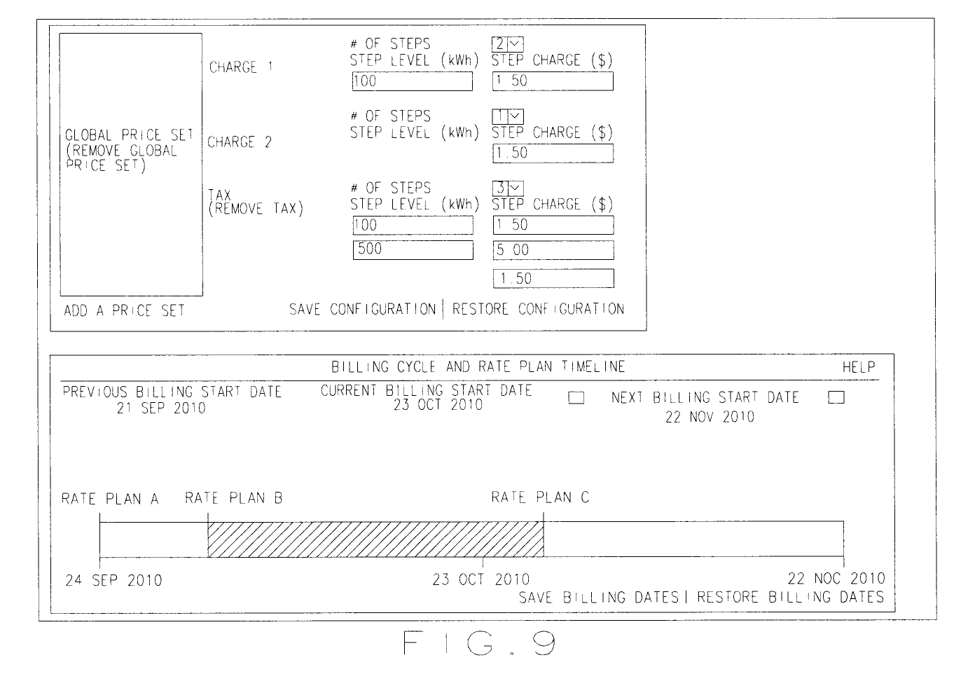

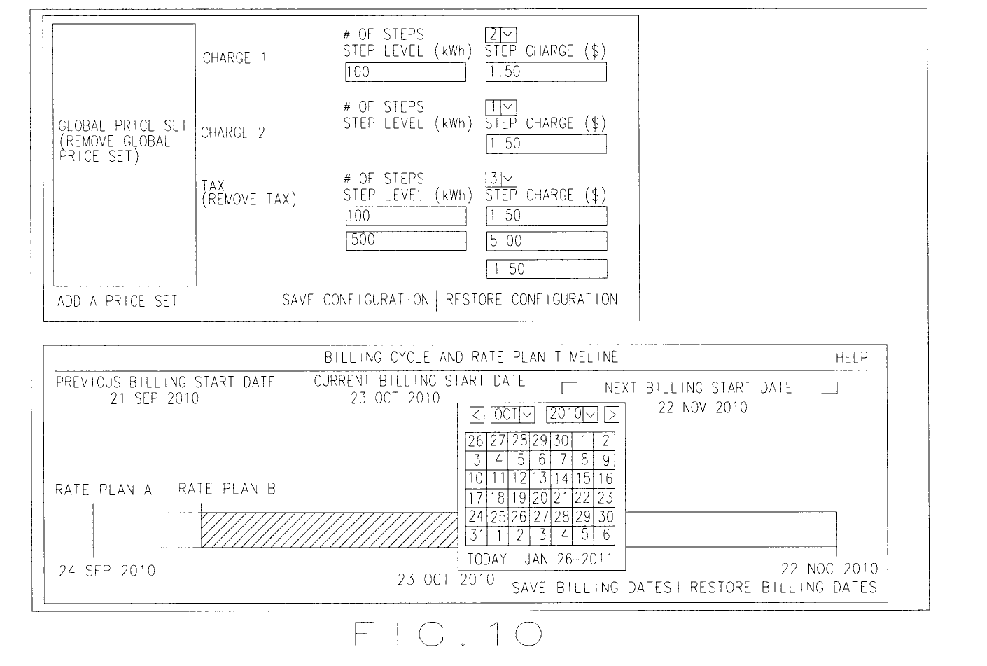

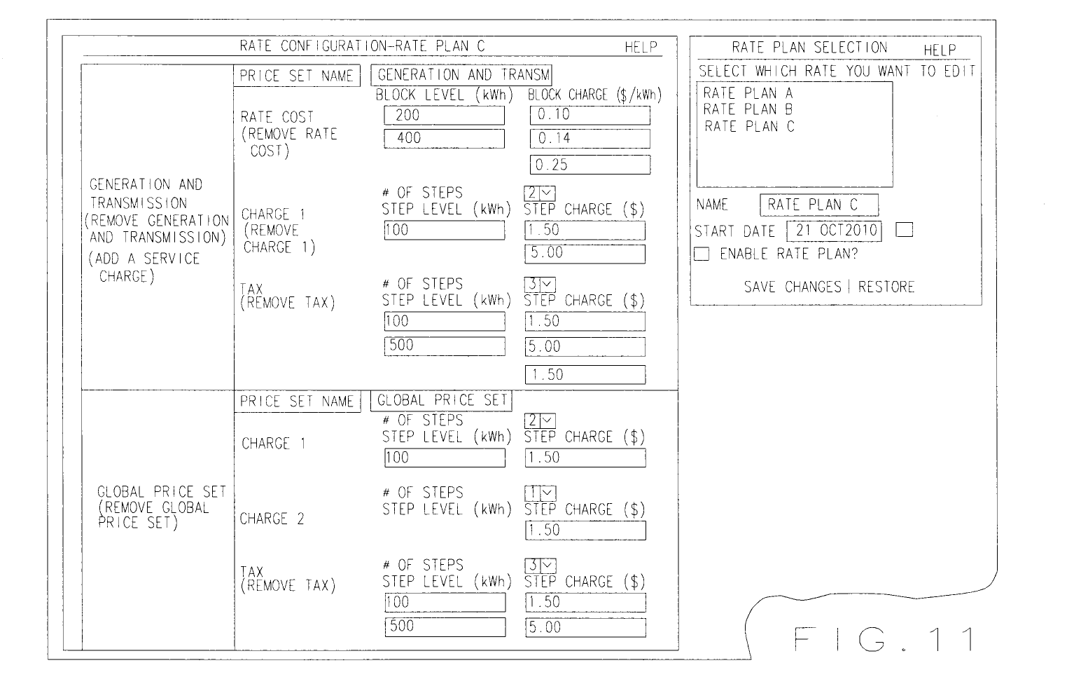

Referring to FIGS. 5-11, they depict a variety of web pages which can be presented to a customer as a screen display on his selected device D. FIG. 5 shows the cost of energy usage and FIG. 6 displays energy usage over a particular 24-hour period. FIG. 7 is a display for cumulative cost of energy use over that period. FIG. 8 is a display showing the cost of daily energy usage over a thirty day period which, for example, corresponds to the billing cycle of the utility. FIG. 9 displays the rate breakdown over a billing cycle and FIG. 10 the configurability of the date information. Finally, FIG. 11 is a display of rate configuration for a selected billing rate (rate C). Those skilled in the art will understand that other displays, not shown, are available. Some of these displays are available to all customers of the utility, while other displays may be customized for the needs of a particular customer.

In the displays, values are dynamically updated using AJAX and supporting JavaScript, for example, while all else in the display is generated using HTML and CSS. The displays may employ a standard web browser such as Firefox®, Internet Explorer®, Chrome®, Safari®, Opera®, for example; or a non-standard proprietary browser that is compatible with the features employed by the server, and it will be understood that the display can as readily appear on a smart phone display, or other customer device D with a standard web browser such as Mobile Safari®, Opera Mini®, etc.

Using meter M, other features are available to the customer. For example, web server S can provide data to an “embedded” device such a thermostat. If the customer programmed the thermostat to indicate that only X dollars of electricity over a given period of time was to be used for heating and cooling, the thermostat could automatically adjust its settings to achieve this goal.

Or, end user appliances or equipment (refrigerators, freezers, industrial machinery) can be equipped to request power through meter M. These appliances and this equipment are, for example, internet enabled. The communications between the meter and appliances or equipment is important because it allows the customer to program the appliance or equipment about prospective electrical usage before it is turned “on”. This, in turn, enables usage decisions to be made taking into account time of day when the appliance or equipment will be used so to account for electricity rate fluctuations, settings limits on how long the appliance or equipment is to be used; i.e., dollar amount of usage as in the thermostat example above; or, times of turn “on” and turn “off” if the customer only wants to use the equipment when a certain rate (or rates) are in effect; or, when other conditions (room temperature falls below or rises above a set temperature) exist. Accordingly, an appropriately configured appliance is able to obtain utility pricing and related information from meter M which enables the appliance to, in effect, know when, and for how long, it can most cost efficiently operate.

With regard to electronic messaging, if an internet connection is available between meter M and the customer, the customer could, via a webpage, set up their usage or cost to be linked to their Facebook® page or Twitter® account, an RSS (Really Simple Syndication) feed, etc. Further, the data and information provided by the meter or utility could also be made available to other third party applications such as Google® Power Meter.

Overall, the features of the invention include:

the ability to send email messages to or from the customer;

the ability to send text messages and alerts from the server to the customer;

the ability to transfer files to the customer;

encryption of emails, data, messages and files;

downloading of firmware;

enabling a third party software/hardware interface with the server so to, for example, upload web pages;

the ability to switch from current to new protocols as they come into use;

dynamic customization for a customer;

enabling a utility to remotely upload web pages so data can be presented in different formats with the customer as well as being able to configure the settings on a page;

unlock features to paying customers.

Finally, meter M, besides being an electric meter, can also be, for example, a water meter or a gas meter. In many facilities, there are separate meters for each commodity provided by the appropriate utility to the premises. In accordance with the invention, web server S can be installed in one of the meters and, using a separate interface, communicates with one or more of these other meters. In such an installation, all the data and information from the other meters can be collected by the one meter and then provided to the user (i.e., the customer. This allows all the relevant usage data for all the metered utilities to be displayed to the customer on a web page provided by the first meter.

In addition, it will be understood by those skilled in the art that while the above description addresses web servers incorporated with utility meters, an embedded web server can also be implemented in other appliances or devices such as a demand response unit or DRU. In such installations, it enables configuration control of the unit and its settings to an end consumer.

In view of the above, it will be seen that the several objects and advantages of the present disclosure have been achieved and other advantageous results have been obtained.

Having thus described the invention, what is claimed and desired to be secured by Letters Patent is:

1. A meter installed by a utility at a customer site to measure the usage of a commodity supplied by the utility to the customer comprising:
an enclosure in which is installed measuring means for measuring the amount of usage of the commodity by the customer at any point in time;
a web server also installed within the enclosure for providing information obtained from the measuring means and the utility to the customer; and,
means installed within the enclosure providing a wireless connection between the web server and a customer device(s) on which the meter information and utility provided information is displayed to the customer.

2. The meter of claim 1 in which the means installed within the enclosure and providing the wireless connection between the web server and the customer device(s) enables a device to obtain pricing information from the meter by which it can be determined when, and for how long, the appliance can be most cost efficiently operated.

3. The meter of claim 1 which is one of an electric meter for measuring electricity usage, a water meter for measuring water usage, or a natural gas meter for measuring natural gas usage, and which provides access to meter information and utility information using a common wireless interface.

4. The meter of claim 1 in which the customer device has a wireless capability for communicating with the web server of the meter and includes at least one of a personal computer (PC) including a laptop computer, a television (TV), a smart phone, a personal digital assistant (PDA), a game console, an entertainment center, and an appliance capable of wireless communication with the web server and including a household appliance, a demand response unit, and business machinery and equipment.

5. The meter of claim 4 providing wireless access using the IEEE 802.11 standard.

6. The meter of claim 5 in which the web server is connected to the customer device through either a Wi-Fi router or via a direct connection.

7. The meter of claim 1 in which meter information and utility provided information is provided to the customer using a standard web browser protocol connecting directly to the meter and requiring no internet access.

8. The meter of claim 1 further including a secure connection over which the meter information and utility provided information is supplied to the customer.

9. The meter of claim 3 in which at least one other meter is installed at the customer site with the web server being installed in one of the meters and communicating, through a separate interface, with the other meter, the other meter providing its meter information and its utility provided information to said one meter.

10. The meter of claim 9 in which the data and information from the other meter is displayed on a web page provided by said one meter.

11. A method of supplying commodity usage information to a customer of a utility providing the commodity comprising:
installing a meter at a customer site, the meter including an enclosure in which is installed measuring means for measuring the amount of usage of the commodity by the customer at any point in time, a web server for providing information obtained from the measuring means to the customer; and means providing a wireless connection between the web server and a customer device on which the meter information is displayed to the customer; and,
the customer device being capable of wireless connection to the meter.

12. The method of claim 11 in which the means installed within the enclosure and providing the wireless connection between the web server and the customer device(s) enables a device to obtain usage and pricing information from the meter by which it can be determined when, and for how long, the appliance can be most cost efficiently operated.

13. The method of claim 11 in which the meter is one of an electric meter for measuring electricity usage, a water meter for measuring water usage, or a natural gas meter for measuring natural gas usage, and which provides access to meter information and utility information using a common wireless interface.

14. The method of claim 13 in which the utility also provides information to the meter and the web server further provides the information obtained from the utility to the customer together with the meter information.

15. The method of claim 14 in which the customer device includes at least one of a personal computer (PC) including a laptop computer, a television (TV), a smart phone, a personal digital assistant (PDA), a game console, media device, home appliance, an entertainment center, a household appliance, a demand response unit, and business machinery and equipment.

16. The method of claim 15 further including providing access to the meter information and utility information using one of Wi-Fi, a common wireless interface, or a direct connection.

17. The method of claim 16 for providing wireless access using the IEEE 802.11 standard.

18. The method of claim 11 in which meter information and utility provided information is provided to the customer using a standard web browser protocol wirelessly connecting directly to the meter and requiring no internet access.

19. The method of claim 11 further including providing a secure connection over which the meter information and utility provided information is supplied to the customer.

20. The method of claim 13 in which at least one other one meter is installed at the customer site and the method further includes installing the web server in one of the meters and communicating, through a separate interface, with the other meter, the other meter providing its meter information and its utility provided information to said one meter, the meter information and utility information provided to the other meter being displayed on a web page provided by said one meter.
